(19) United States
(12) Patent Application Publication
(10) Pub. No.: US 2026/0112779 A1
(43) Pub. Date: Apr. 23, 2026

(54) SEPARATOR FOR CYLINDRICAL ELECTROCHEMICAL DEVICE AND CYLINDRICAL ELECTROCHEMICAL DEVICE INCLUDING THE SAME

(71) Applicant: LG ENERGY SOLUTION, LTD., Seoul (KR)

(72) Inventors: Hye Won KIM, Daejeon (KR); Kyung Ryun KA, Daejeon (KR); In Hyouk SUNG, Daejeon (KR); Jin Young SHIN, Daejeon (KR); Seung Hyun LEE, Daejeon (KR); So Young YOON, Daejeon (KR)

(21) Appl. No.: 19/360,741

(22) Filed: Oct. 16, 2025

(30) Foreign Application Priority Data
Oct. 18, 2024 (KR) 10-2024-0142798

(51) Int. Cl. H01M 50/451; H01M 10/0587; H01M 50/42; H01M 50/423; H01M 50/443; H01M 50/446; H01M 50/489

(52) U.S. Cl. CPC H01M 50/451; H01M 10/0587; H01M 50/42; H01M 50/423; H01M 50/443; H01M 50/446; H01M 50/489

(57) ABSTRACT

A separator for a cylindrical electrochemical device of the present disclosure includes: a porous polymer substrate; and a coating layer provided on at least one surface of the porous polymer substrate and including a polymer binder and inorganic particles. The polymer binder included in the coating layer includes an electrolyte-resistant polymer binder and a binding polymer binder, and the peeling strength of the separator is about 150 gf/cm or more.

### CROSS REFERENCES TO RELATED APPLICATIONS

This application is based on and claims priority from Korean Patent Application No. 10-2024-0142798, filed on Oct. 18, 2024, with the Korean Intellectual Property Office, the disclosure of which is incorporated herein in its entirety by reference.

### TECHNICAL FIELD

The present disclosure relates to a separator for a cylindrical electrochemical device and a cylindrical electrochemical device including the same.

### BACKGROUND

An electrochemical device converts chemical energy into electrical energy using an electrochemical reaction, and in recent years, lithium secondary batteries, which have high energy density and voltage, long cycle life, and are applicable in various fields, have been widely used.

A lithium secondary battery may include an electrode assembly manufactured using a positive electrode, a negative electrode, and a separator disposed between the positive electrode and the negative electrode, and the electrode assembly may be accommodated in a case together with an electrolyte.

### SUMMARY

The present disclosure provides a separator for a cylindrical electrochemical device, and a cylindrical electrochemical device including the same, in which the separator includes an electrolyte-resistant polymer binder in a coating layer of the separator such that the separator has high peeling strength and damage in the separator is minimized.

However, the present disclosure is not limited to the above-mentioned characteristics, and other characteristics not mentioned will be clearly understood by those ordinarily skilled in the art from the following description.

An embodiment of the present disclosure provides a separator for a cylindrical electrochemical device including a porous polymer substrate, and a coating layer provided on at least one surface of the porous polymer substrate and including a polymer binder and inorganic particles. The polymer binder included in the coating layer includes an electrolyte-resistant polymer binder and a binding polymer binder, and the separator has a peeling strength of about 150 gf/cm or more.

The content of the inorganic particles included in the coating layer may be about 90 parts by weight or more and 99 parts by weight or less, based on 100 parts by weight of the coating layer.

The content of the polymer binder included in the coating layer may be about 1 part by weight or more and about 10 parts by weight or less, based on 100 parts by weight of the coating layer.

The content of the electrolyte-resistant polymer binder included in the coating layer may be about 0.5 part by weight or more and about 5 parts by weight or less, based on 100 parts by weight of the coating layer.

The electrolyte-resistant polymer binder included in the coating layer may include one or more selected from polyacrylamide (PAM), styrene-co-acrylonitrile (SAN), polyether ether ketone (PEEK), and polyether sulfone (PES).

The content of the binding polymer binder included in the coating layer may be about 1 part by weight or more and about 8 parts by weight or less, based on 100 parts by weight of the coating layer.

The content ratio of the electrolyte-resistant polymer binder to the binding polymer binder included in the coating layer may be about 1:2 to about 2:1.

The electrolyte solubility of the electrolyte-resistant polymer binder included in the coating layer may be about 0% or more and about 10% or less.

The electrolyte swelling degree of the electrolyte-resistant polymer binder included in the coating layer may be about 0% or more and about 20% or less.

The thickness of the coating layer may be about 1 μm or more and about 3 μm or less.

According to an embodiment of the present disclosure, there is provided a cylindrical electrochemical device including a positive electrode, a negative electrode, and a separator interposed between the positive electrode and the negative electrode, the separator being any one of the above-described separators.

The separator for a cylindrical electrochemical device according to an embodiment of the present disclosure may have increased peeling strength and secure electrolyte resistance by including an electrolyte-resistant polymer binder in the coating layer.

The cylindrical electrochemical device according to an embodiment of the present disclosure may prevent damage to the separator and hence improve battery lifetime characteristics by including an electrolyte-resistant polymer binder in the coating layer.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic diagram illustrating the damage in the separator occurring during a winding process of a cylindrical electrochemical device of a comparative example, according to an embodiment of the present disclosure.

FIG. 2 is a schematic view illustrating the damage in the separator and by-product growth after electrolyte injection into a separator of a comparative example, according to an embodiment of the present disclosure.

FIG. 3 is a schematic view of a separator for a cylindrical electrochemical device, according to an embodiment of the present disclosure.

FIG. 4 is a schematic view illustrating a separator after electrolyte injection, according to an embodiment of the present disclosure.

FIG. 5 is a schematic view illustrating a winding process of a cylindrical electrochemical device, according to an embodiment of the present disclosure.

FIG. 6 is a SEM image illustrating the surface of a separator of Example 1, according to an embodiment of the present disclosure.

FIG. 7 is a SEM image illustrating the surface of a separator of Example 2, according to an embodiment of the present disclosure.

FIG. 8 is a SEM image illustrating the surface of a separator of Comparative Example 1, according to an embodiment of the present disclosure.

FIG. 9 is a SEM image illustrating the surface of a separator of Comparative Example 2, according to an embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Herein, when a part is described as “including” a component, this means that, unless otherwise specified, it does not exclude other components but may further include other components.

Herein, “A and/or B” means “A and B, or A or B.”

Herein, terms “about,” “approximately,” and “substantially” are used to mean a range of numerical values or degrees (e.g., ±5%), or approximations thereof, considering inherent manufacturing and material tolerances, and are used to prevent an infringer from unfairly exploiting the described content where precise or absolute values are mentioned to aid understanding of the present disclosure.

Herein, when an element is described as being provided “on” another element, it means that, unless specifically stated otherwise, it does not exclude the possibility that another element may be interposed therebetween, but allows that other elements may also be disposed therebetween.

Herein, the characteristic having pores means that an object contains a plurality of pores and allows gaseous and/or liquid fluid to pass from one surface to the other surface of the object due to a structure in which the pores are connected to each other.

Herein, the separator has a porous property including multiple pores and serves as a porous ion-conducting barrier that blocks electrical contact between the negative electrode and the positive electrode in an electrochemical device while allowing ions to pass therethrough.

Herein, the term “wet state’ may refer to a state in which the separator is impregnated with at least a portion of the electrolyte, and the term “dry state” may refer to a state in which the separator is not impregnated with the electrolyte and remains in a dry condition.

Herein, the term “electrolyte resistance” may refer to a property of a binder that exhibits adhesion or mechanical strength as its inherent physical property without swelling or dissolving when brought into contact with the electrolyte.

Among the components of an electrochemical device, the separator may include a polymer substrate having a porous structure positioned between a positive electrode and a negative electrode, and the separator serves to isolate the positive electrode and the negative electrode so as to prevent an electrical short circuit between the two electrodes, while simultaneously allowing an electrolyte and ions to pass therethrough. Although the separator itself does not participate in the electrochemical reaction, physical properties such as wettability to the electrolyte, porosity, and thermal shrinkage ratio may affect the performance and safety of the electrochemical device.

Accordingly, in order to enhance the physical properties of such a separator, various methods have been attempted in which a coating layer is added to a porous polymer substrate and various materials are further included in the coating layer to improve the physical properties of the coating layer. For example, in order to improve the mechanical strength of the separator, an inorganic material may be added to the coating layer, or an inorganic material or a hydrate for improving the flame retardancy and heat resistance of the polymer substrate may be added to the coating layer.

In the coating layer, the inorganic particles may be connected to other inorganic particles by a polymer binder to form an interstitial volume, and lithium ions may migrate through the interstitial volume. For example, a coating layer including a polymer binder and inorganic particles may serve to prevent thermal shrinkage of the separator while simultaneously facilitating the migration of lithium ions through the separator.

Meanwhile, as the types of secondary battery cells, cylindrical, prismatic, and pouch-type battery cells are known. In the case of a cylindrical battery cell, an insulating separator is interposed between a positive electrode and a negative electrode, and the separator and electrodes are wound to form a jelly-roll type electrode assembly, which is then inserted into a battery can, and an electrolyte is injected to constitute the battery.

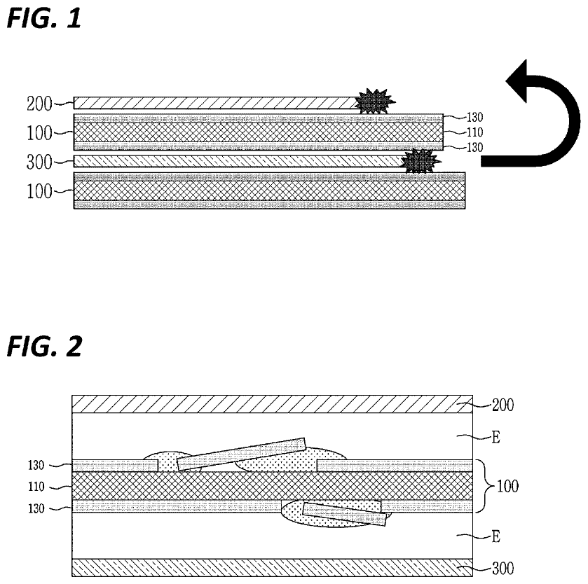

FIG. 1 is a schematic diagram illustrating the damage in the separator occurring during a winding process of a cylindrical electrochemical device of a comparative example, according to an embodiment of the present disclosure. FIG. 2 is a schematic view illustrating the damage to a coating layer 130 of a separator 100 and by-product growth after electrolyte E injection into the separator of a comparative example, according to an embodiment of the present disclosure.

Referring to FIGS. 1 and 2, a cylindrical electrochemical device of a comparative example according to an embodiment of the present disclosure includes a separator 100, a positive electrode 200, and a negative electrode 300, and the separator 100 includes a porous polymer substrate 110 and coating layers 130 provided on both surfaces of the porous polymer substrate 110. During the winding process in assembling such a cylindrical battery cell, due to the tension applied to the separator 100 and the step difference at the ends of the positive electrode 200 and the negative electrode 300, the coating layer 130 of the separator 100 at the step-difference portion may be damaged during cell assembly. Due to such damage to the coating layer 130, by-products generated during cell operation after electrolyte injection may grow between the damaged coating layers 130 of the separator 100, or lithium plating may occur, which may cause degradation of battery lifetime. In addition, not only during cell assembly but also during cell operation after electrolyte injection, the coating layer 130 at the step-difference portion may swell or dissolve, which may cause damage to the separator 100 due to physical impact. For these reasons, when the coating layer 130 of the separator 100 is damaged and by-products grow after electrolyte E injection, battery lifetime degradation may occur.

The present disclosure provides a technique for preventing damage to a coating layer 130 of a separator 100 caused by a stepped portion of ends of a positive electrode 200 and a negative electrode 300 during cylindrical battery cell assembly and operation.

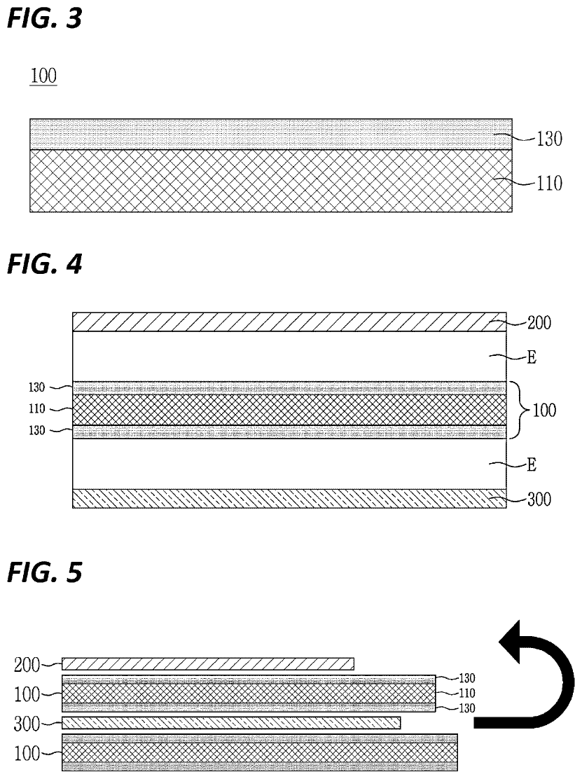

FIG. 3 is a schematic view of a separator 100 for a cylindrical electrochemical device, according to an embodiment of the present disclosure.

An embodiment of the present disclosure includes a porous polymer substrate 110, and a coating layer 130 provided on at least one surface of the porous polymer substrate 110 and including a polymer binder and inorganic particles. The polymer binder included in the coating layer 130 includes an electrolyte-resistant polymer binder and a binding polymer binder, and the separator 100 for a cylindrical electrochemical device has a peeling strength of about 150 gf/cm or more.

The separator 100 for a cylindrical electrochemical device according to an embodiment of the present disclosure may have increased peeling strength and secure electrolyte resistance by including the electrolyte-resistant polymer binder in the coating layer 130.

The separator 100 for the electrochemical device includes the porous polymer substrate 110. As described above, since the separator 100 for the electrochemical device includes the porous polymer substrate 110, the separator may allow lithium ions to pass therethrough while blocking electrical contact, and may implement a shutdown function at an appropriate temperature. The shutdown function refers to a function of preventing thermal runaway by blocking the pores of the separator when the battery overheats, thereby cutting off the current flow. Specifically, when the internal temperature of the battery rises above a certain temperature, the separator melts to block the pores, thereby cutting off the contact between the positive electrode and the negative electrode and stopping the current flow.

According to an embodiment of the present disclosure, the porous polymer substrate 110 may be manufactured using a polyolefin-based resin as a base resin. Examples of the polyolefin-based resin may include polyethylene, polypropylene, and polypentene, and the porous polymer substrate may include one or more of these. A porous separator having multiple pores and manufactured using such a polyolefin-based resin as a base resin may provide a shutdown function at an appropriate temperature.

According to an embodiment of the present disclosure, the weight-average molecular weight of the polyolefin-based resin may be about 500,000 or more and about 1,500,000 or less. By adjusting the weight-average molecular weight of the polyolefin-based resin within the above range, the compressive resistance of the separator may be improved. Furthermore, in a case where different polyolefin-based resins are mixed for use, or a multilayer structure of the separator is formed of different polyolefin-based resins, the weight-average molecular weight of the polyolefin-based resin may be calculated by adding the weight-average molecular weights according to the content ratio of respective polyolefin-based resins.

Herein, the weight-average molecular weight (Mw) may be measured by gel permeation chromatography (GPC: PL GPC220, Agilent Technologies), and according to an embodiment, the measurement conditions may be set as follows:
Column: PL Olexis (Polymer Laboratories Co.)
Solvent: trichlorobenzene (TCB)
Flow rate: 1.0 ml/min
Sample concentration: 1.0 mg/ml
Injection volume: 200 μl
Column temperature: 160° C.
Detector: Agilent High Temperature RI detector
Standard: Polystyrene (calibrated by a cubic function)

According to an embodiment of the present disclosure, the porous polymer substrate 110 may be manufactured by a wet process in which a polyolefin-based resin is kneaded with a plasticizer (diluents) at a high temperature to form a single phase, the polymer material and the plasticizer are phase-separated during a cooling process, pores are formed by extracting the plasticizer, and then stretching and heat-setting treatments are performed.

According to an embodiment of the present disclosure, the average size and maximum size of the pores of the porous polymer substrate 110 may be easily controlled by those ordinarily skilled in the art to conform to the scope of the present disclosure by adjusting factors such as the mixing ratio of the plasticizer, stretching ratio, and heat-setting treatment temperature.

According to an embodiment of the present disclosure, the thickness of the porous polymer substrate 110 may be about 8 μm or more and about 15 μm or less. For example, the thickness of the porous polymer substrate 110 may be about 8 μm or more and about 14 μm or less, about 8 μm or more and about 13 μm or less, about 8 μm or more and about 12 μm or less, about 8 μm or more and about 11 μm or less, or about 9 μm or more and about 11 μm or less, and may be 10 μm according to an embodiment. By adjusting the thickness of the porous polymer substrate 110 within the above range, the energy density of the battery may be improved.

According to an embodiment of the present disclosure, the thickness of the porous polymer substrate 110 may be measured, for example, by a contact measurement method using a thickness gauge (Mitutoyo Co., VL-50S-B).

According to an embodiment of the present disclosure, the porosity of the porous polymer substrate 110 may be about 10 vol % or more and about 90 vol % or less. For example, the porosity of the porous polymer substrate 110 may be about 10 vol % or more and about 90 vol % or less, about 20 vol % or more and about 80 vol % or less, about 30 vol % or more and about 70 vol % or less, or about 40 vol % or more and about 60 vol % or less. By adjusting the porosity of the porous polymer substrate 110 within the above range, the permeability of lithium ions through the separator may be controlled.

According to an embodiment of the present disclosure, the coating layer 130 is provided on at least one surface of the porous polymer substrate 110. As described above, since the separator 100 for an electrochemical device includes the coating layer 130 provided on at least one surface of the porous polymer substrate 110, the heat resistance of the separator may be improved, the mechanical properties may be enhanced, and the separator 100 may be prevented from shrinking at high temperature, which may cause an electrical short circuit at the electrodes.

According to an embodiment of the present disclosure, the coating layer 130 includes a polymer binder and inorganic particles. As described above, since the coating layer 130 includes the polymer binder and the inorganic particles, the heat resistance of the separator may be improved, the mechanical properties may be enhanced, the separator may be prevented from shrining at high temperature, which may cause an electrical short circuit at the electrodes, and pores may be formed inside the coating layer 130.

According to an embodiment of the present disclosure, the coating layer 130 may be formed by the inorganic particles being bound by the polymer binder particles and integrated within the layer. The pores inside the coating layer 130 may be derived from interstitial volumes, which are spaces between the inorganic particles.

According to an embodiment of the present disclosure, the coating layer 130 may include a plurality of pores. For example, the coating layer 130 may be a porous coating layer including a plurality of pores therein. As described above, by including the plurality of pores, the coating layer 130 may allow lithium ions to pass therethrough so that current may flow while physically isolating the negative electrode and the positive electrode.

According to an embodiment of the present disclosure, the thickness of the coating layer 130 formed on one side of the porous polymer substrate 110 may be about 1 μm or more and about 3 μm or less. When the thickness of the coating layer 130 is within the above range, the heat resistance and adhesion of the coating layer may be improved, an increase in resistance may be suppressed, and the overall thickness of the separator 100 may be reduced, thereby positively affecting the assemblability of the battery.

In an embodiment of the present disclosure, the thickness of, for example, the coating layer 130 may be measured by applying a contact-type thickness gauge. As the contact-type thickness gauge, for example, VL-50S-B from Mitutoyo Corporation may be used.

According to an embodiment of the present disclosure, the inorganic particles usable in the coating layer 130 are not particularly limited as long as they are electrochemically stable. For example, in an embodiment of the present disclosure, the inorganic particles usable therein are not particularly limited as long as oxidation and/or reduction reactions do not occur within the operating voltage range of the applied electrochemical device (e.g., 0 V to 5 V based on Li/Li⁺).

According to an embodiment of the present disclosure, non-limiting examples of the inorganic particles may include BaTiO₃, Pb(Zr, Ti)O₃ (PZT), Pb₁₋ₓLaₓZr_{1-γ}Ti_{γ}O₃ (PLZT, 0<x<1, 0<y<1), Pb(Mg_{1/3}Nb_{2/3})O₃—PbTiO₃(PMN-PT), hafnia (HfO₂), SrTiO₃, SnO₂, CeO₂, MgO, Mg(OH)₂, NiO, CaO, ZnO, ZrO₂, SiO₂, Y₂O₃, Al₂O₃, SiC, boehmite (AlO(OH)), Al(OH)₃, TiO₂, aluminum peroxide, zinc tin hydroxide (ZnSn(OH)₆), zinc-tin oxides (Zn₂SnO₄, ZnSnO₃), antimony trioxide (Sb₂O₃), antimony tetroxide (Sb₂O₄), and antimony pentoxide (Sb₂O₅), and one or more of these may be included.

According to an embodiment of the present disclosure, although the average particle diameter (D50) of the inorganic particles is not particularly limited, it may be about 0.1 μm or more and about 1 μm or less in order to form a coating layer 130 of uniform thickness and an appropriate porosity. For example, the average particle diameter (D50) of the inorganic particles may be about 0.2 μm or more and about 0.9 μm or less, about 0.3 μm or more and about 0.8 μm or less, about 0.4 μm or more and about 0.7 μm or less, or about 0.5 μm or more and about 0.6 μm or less. Within the above range of the average particle diameter (D50), the dispersibility of the inorganic particles in the slurry prepared for forming the coating layer 130 may be improved, and the thickness of the formed coating layer may be reduced.

Herein, the term “D50 particle diameter” refers to the particle diameter at the 50% point of the cumulative distribution of the number of particles according to particle diameter. The particle diameter may be measured using a laser diffraction method. For example, after dispersing the powder to be measured in a dispersion medium, the particle size distribution may be calculated by introducing the powder into a commercially available laser diffraction particle size analyzer (e.g., Microtrac S3500) and measuring differences in diffraction patterns according to particle size when the particles pass through a laser beam. By calculating the particle diameter at the 50% point of the cumulative distribution of the number of particles according to particle diameter in the measuring device, the D50 particle diameter may be measured.

According to an embodiment of the present disclosure, the content of the inorganic particles may be about 90 parts by weight or more and about 99 parts by weight or less, based on 100 parts by weight of the coating layer 130. For example, based on 100 parts by weight of the coating layer 130, the content of the inorganic particles may be about 90 parts by weight or more and about 98 parts by weight or less, about 90 parts by weight or more and about 97 parts by weight or less, about 90 parts by weight or more and about 96 parts by weight or less, about 90 parts by weight or more and about 95 parts by weight or less, about 90 parts by weight or more and about 94 parts by weight or less, or about 90 parts by weight or more and about 93 parts by weight or less. Within the above range of the content of the inorganic particles, the heat resistance may be improved, and the binder content may be maintained at an appropriate level, resulting in excellent peeling strength and electrolyte resistance, and reducing delamination of the coating layer during assembly and damage to the coating layer 130 during cycling, thereby improving capacity retention. As such, by adjusting the content of the inorganic particles included in the coating layer 130 within the above range, the heat resistance of the separator 100 may be improved so as to ensure the safety of the battery, while the binder content is adjusted so as to prevent, for example, damage to the coating layer 130 during the winding process.

According to an embodiment of the present disclosure, the content of the polymer binder may be about 1 part by weight or more and about 10 parts by weight or less, based on 100 parts by weight of the coating layer 130. For example, the content of the polymer binder may be about 1 part by weight or more and about 9 parts by weight or less, about 1 part by weight or more and about 8 parts by weight or less, about 1 part by weight or more and about 7 parts by weight or less, about 2 parts by weight or more and about 7 parts by weight or less, or about 2 parts by weight or more and about 6 parts by weight or less, based on 100 parts by weight of the coating layer 130. Within the above range of content, the adhesion and electrolyte resistance of the coating layer 130 may be improved, and the increase in resistance of the separator 100 may be suppressed or the capacity retention of the battery may be improved.

According to an embodiment of the present disclosure, the polymer binder included in the coating layer 130 of the separator 100 includes an electrolyte-resistant polymer binder. As described above, since the polymer binder included in the coating layer 130 of the separator 100 includes the electrolyte-resistant polymer binder, the electrolyte resistance of the battery may be improved.

According to an embodiment of the present disclosure, the content of the electrolyte-resistant polymer binder may be about 0.5 part by weight or more and about 5 parts by weight or less, based on 100 parts by weight of the coating layer. For example, the content of the electrolyte-resistant polymer binder may be about 1 part by weight or more and about 5 parts by weight or less, about 1 part by weight or more and about 4.5 parts by weight or less, about 1 part by weight or more and about 4 parts by weight or less, about 1.5 parts by weight or more and about 4 parts by weight or less, or about 2 parts by weight or more and about 4 parts by weight or less, based on 100 parts by weight of the coating layer. Within the above range of content, the resistance of the separator may be reduced, and the binder may be sufficient to hold the coating layer 130, thereby improving the adhesion of the coating layer 130 or improving the electrolyte resistance of the separator 100.

According to an embodiment of the present disclosure, the electrolyte-resistant polymer binder may include one or more selected from polyacrylamide (PAM), styrene-co-acrylonitrile (SAN), polyether ether ketone (PEEK), and polyether sulfone (PES). By selecting the electrolyte-resistant polymer binder within the above range, the electrolyte resistance of the separator 100 may be increased and damage to the coating layer 130 may be prevented or suppressed, thereby improving the capacity retention of the battery.

In conventional separators, poly(acrylic acid) (PAA)-based binders used in the coating layer may swell and dissolve in the electrolyte, which may cause damage to the separator due to physical impact after electrolyte injection. By selecting the electrolyte-resistant polymer binder within the above range, the separator 100 may not significantly swell even after electrolyte injection, thereby minimizing damage to the separator 100.

According to an embodiment of the present disclosure, the polymer binder includes a binding polymer binder. As described above, since the polymer binder includes the binding polymer binder, the binding force between the inorganic particles in the coating layer 130 and the binding force between the porous polymer substrate 110 and the coating layer 130 may be improved.

According to an embodiment of the present disclosure, the binding polymer binder may be an acrylic-based binder, a polyvinylidene-based binder, or a combination thereof. The combination of the acrylic-based binder and the polyvinylidene-based binder may be a mixture of the acrylic-based binder and the polyvinylidene-based binder, a copolymer including acrylic repeating units and polyvinylidene repeating units, or a hybrid of the acrylic-based binder and the polyvinylidene-based binder. In addition, the polyvinylidene-based binder may be a copolymer of polyvinylidene fluoride (PVdF) and hexafluoropropylene (HFP). By selecting the binding polymer binder as described above, the porosity of the separator may be maintained, and the binding force between the porous polymer substrate 110 and the coating layer 130, and between the inorganic particles in the coating layer 130, may be improved during the winding process of the battery, thereby facilitating the manufacture of the battery and improving delamination of the coating layer 130 during the manufacturing process. Furthermore, the porosity of the separator 100 may be maintained, and adhesion may be retained even when the coating layer 130 is wetted by the electrolyte after activation of the battery.

According to an embodiment of the present disclosure, the acrylic-based binder may be a polymer including carboxylic acid ester as a repeating unit, and may be, for example, a (meth)acrylic acid ester or an acryl-styrene copolymer.

According to an embodiment of the present disclosure, the (meth)acrylic acid ester may be one or more selected from (meth)acrylic acid methyl, (meth)acrylic acid ethyl, (meth)acrylic acid n-propyl, (meth)acrylic acid i-propyl, (meth)acrylic acid n-butyl, (meth)acrylic acid i-butyl, (meth)acrylic acid n-amyl, (meth)acrylic acid i-amyl, (meth)acrylic acid hexyl, (meth)acrylic acid cyclohexyl, (meth)acrylic acid 2-ethylhexyl, (meth)acrylic acid n-octyl, (meth)acrylic acid nonyl, (meth)acrylic acid decyl, (meth)acrylic acid hydroxymethyl, (meth)acrylic acid hydroxyethyl, (meth)acrylic acid ethylene glycol, di(meth)acrylic acid ethylene glycol, di(meth)acrylic acid propylene glycol, tri(meth)acrylic acid trimethylolpropane, tetra(meth)acrylic acid pentaerythritol, hexa(meth)acrylic acid dipentaerythritol, (meth)acrylic acid allyl, and di(meth)acrylic acid ethylene. Among these, the (meth)acrylic acid ester may be one or more selected from (meth)acrylic acid methyl, (meth)acrylic acid ethyl, and (meth)acrylic acid 2-ethylhexyl, or may be (meth)acrylic acid methyl.

According to an embodiment of the present disclosure, the acryl-styrene copolymer may include an acrylic-based binder, and the acrylic-based binder may be a polyacrylate-based binder. For example, the binder may be one or more selected from styrene-butyl acrylate, styrene-butadiene rubber, nitrile-butadiene rubber, acrylonitrile-butadiene rubber, acrylonitrile-butadiene-styrene rubber, and acrylate-based polymers, and may be, for example, a copolymer including acrylate.

According to an embodiment of the present disclosure, the polyvinylidene-based binder may be a polyvinylidene-based binder in which the content of hexafluoropropylene (HFP) is about 1% by weight or more and about 50% by weight or less. For example, in the polyvinylidene-based binder, the content of hexafluoropropylene (HFP) may be about 1% by weight or more and about 50% by weight or less, about 2% by weight or more and about 45% by weight or less, about 3% by weight or more and about 40% by weight or less, about 4% by weight or more and about 35% by weight or less, about 5% by weight or more and about 30% by weight or less, about 7% by weight or more and about 25% by weight or less, or about 10% by weight or more and about 20% by weight or less. As described above, by selecting the polyvinylidene-based binder as a polyvinylidene-based binder in which the content of hexafluoropropylene is about 1% by weight or more and about 50% by weight or less, the porosity of the separator 100 may be maintained, and adhesion may be retained even when the coating layer 130 is wetted by the electrolyte after activation of the battery. Herein, the degree of substitution of the polyvinylidene-based binder may refer to the weight ratio including hexafluoropropylene.

According to an embodiment of the present disclosure, the average particle diameter (D50) of the binding polymer binder is not particularly limited, but may be in the range of about 0.1 μm or more and about 1 μm or less so as to form a coating layer 130 having a uniform thickness and an appropriate porosity. For example, the average particle diameter (D50) of the polymer binder may be about 0.1 μm or more and about 0.8 μm or less, about 0.1 μm or more and about 0.6 μm or less, about 0.1 μm or more and about 0.4 μm or less, or about 0.1 μm or more and about 0.2 μm or less. By adjusting the average particle diameter (D50) of the binding polymer binder within the above range, the dispersibility in the slurry prepared for forming the coating layer 130 may be improved, and the thickness of the coating layer 130 to be formed may be reduced.

According to an embodiment of the present disclosure, the content of the binding polymer binder may be about 1 part by weight or more and about 8 parts by weight or less, based on 100 parts by weight of the coating layer 130. For example, the content of the binding polymer binder may be about 1 part by weight or more and about 7 parts by weight or less, about 1 part by weight or more and about 6 parts by weight or less, about 1 part by weight or more and about 5 parts by weight or less, about 1 part by weight or more and about 4 parts by weight or less, or about 2 parts by weight or more and about 4 parts by weight or less, based on 100 parts by weight of the coating layer 130. Within the above range of content, the binding force between the porous polymer substrate 110 and the coating layer 130, and between the inorganic particles in the coating layer 130, may be improved during the winding process of the battery, and the resistance of the separator 100 may be reduced.

According to an embodiment of the present disclosure, the content ratio of the electrolyte-resistant polymer binder to the binding polymer binder may be about 1:2 to 2:1. For example, the content ratio of the electrolyte-resistant polymer binder to the binding polymer binder may be about 1:2 to 1:5 or about 2:1 to 5:1. Within the above range of the content ratio, an increase in resistance of the separator 100 and deterioration of electrolyte resistance may be suppressed.

According to an embodiment of the present disclosure, the electrolyte solubility of the electrolyte-resistant polymer binder may be about 0% or more and about 10% or less. The electrolyte E solubility may refer to a physical property indicating how much of the polymer is dissolved in the electrolyte E. For example, in order to measure the electrolyte E solubility of the electrolyte-resistant polymer binder, the weight of the electrolyte-resistant polymer binder in a dry state may be measured, and then the electrolyte-resistant polymer binder may be dissolved in the electrolyte E, and the weight of the electrolyte-resistant polymer binder remaining without being dissolved may be measured, thereby determining the electrolyte E solubility. When the electrolyte E solubility of the electrolyte-resistant polymer binder is maintained within the above range, dissolution of the binder in the electrolyte E may be reduced, thereby suppressing damage to the coating layer 130 and improving battery performance.

According to an embodiment of the present disclosure, the swelling degree of the electrolyte E of the electrolyte-resistant polymer binder may be about 0% or more and about 20% or less. The electrolyte E swelling degree may refer to a physical property indicating how much the polymer expands when in contact with the electrolyte E. For example, in order to measure the electrolyte E swelling degree of the electrolyte-resistant polymer binder, the weight of the electrolyte-resistant polymer binder in a dry state may be measured, and then the electrolyte-resistant polymer binder may be immersed in the electrolyte E, and the weight of the swollen polymer binder may be measured, thereby determining the electrolyte E swelling degree. When the electrolyte E swelling degree of the electrolyte-resistant polymer binder is maintained within the above range, the increase of the binder swelling in the electrolyte E may be suppressed, thereby reducing damage to the coating layer and improving battery performance.

FIG. 4 is a schematic view illustrating a separator 100 after electrolyte E injection, according to an embodiment of the present disclosure.

According to an embodiment of the present disclosure, the peeling strength of the separator 100 for a cylindrical electrochemical device is about 150 gf/cm or more. For example, the peeling strength of the separator 100 for a cylindrical electrochemical device may be about 150 gf/cm or more and about 300 gf/cm or less, about 160 gf/cm or more and about 290 gf/cm or less, about 160 gf/cm or more and about 280 gf/cm or less, about 160 gf/cm or more and about 270 gf/cm or less, about 160 gf/cm or more and about 260 gf/cm or less, about 160 gf/cm or more and about 250 gf/cm or less, about 170 gf/cm or more and about 240 gf/cm or less, about 180 gf/cm or more and about 230 gf/cm or less, about 190 gf/cm or more and about 220 gf/cm or less, or about 190 gf/cm or more and about 210 gf/cm or less. When the peeling strength of the separator 100 is maintained within the above range, the binding force between the porous polymer substrate 110 and the coating layer 130 may be ensured, which may reduce the probability that the coating layer 130 will be delaminated from the porous polymer substrate 110, and may smoothly provide a pathway for lithium ions during charging/discharging so as to improve capacity retention.

Here, the peeling strength of the separator 100 refers to the force required to peel the coating layer 130 and the porous polymer substrate 110, measured by attaching an adhesive tape to the surface portion of the coating layer of the separator 100 having a size of 7 cm×2 cm, mounting an end portion of the separator 100 on a UTM device (LLOYD Instrument LF Plus), and applying force at a speed of 300 mm/min at 180°

In the case of a cylindrical electrochemical device, since the electrode assembly is accommodated in a cylindrical can, high adhesion strength between the electrode and the separator 100 is not required, and even with minimal adhesion, no problem arises in the performance of the battery. Therefore, the content of the binder may be reduced compared to a stacked battery.

According to an embodiment of the present disclosure, there is provided a method of manufacturing a separator for a cylindrical electrochemical device. The method may include steps of: preparing a porous polymer substrate 110; forming a coating layer 130 by applying a slurry for the coating layer including an electrolyte-resistant polymer binder on at least one surface of the porous polymer substrate 110; and drying the separator 100 which is coated with the coating layer 130. The porous polymer substrate 110, the electrolyte-resistant polymer binder, and the coating layer 130 are as described above.

According to an embodiment of the present disclosure, the method of coating the slurry for the coating layer on the porous polymer substrate 110 may use a conventional coating method, and various methods such as bar coating, dip coating, die coating, roll coating, comma coating, or a combination thereof may be used.

An embodiment of the present disclosure includes a cylindrical electrochemical device including: a positive electrode 200; a negative electrode 300; and a separator 100 interposed between the positive electrode 200 and the negative electrode 300.

The cylindrical electrochemical device according to an embodiment of the present disclosure may prevent or suppress damage to the separator and hence improve battery lifetime characteristics by including an electrolyte-resistant polymer binder in the coating layer 130.

According to an embodiment of the present disclosure, the positive electrode 200 includes a positive electrode current collector and a positive electrode active material layer provided on at least one surface of the current collector. The positive electrode active material layer includes a positive electrode active material, a conductive material, and a binder resin. The positive electrode active material may include one or a mixture of two or more selected from: layered compounds such as lithium manganese complex oxide (e.g., LiMn₂O₄ or LiMnO₂), lithium cobalt oxide (LiCoO₂), and lithium nickel oxide (LiNiO₂) or compounds substituted with one or more transition metals; lithium manganese oxides such as those expressed by the chemical formula Li₁₊ₓMn₂-xO₄ (where x is 0 to 0.33), LiMnO₃, LiMn₂O₃, and LiMnO₂; lithium copper oxide (Li₂CuO₂); vanadium oxides such as LiV₃O₈, LiV₃O₄, V₂O₅, and Cu₂V₂O₇; Ni site type lithium nickel oxide expressed by the chemical formula LiNi₁₋ₓMₓO₂ (where M=Co, Mn, Al, Cu, Fe, Mg, B or Ga, and x=0.01 to 0.3); lithium manganese complex oxides expressed by the chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which part of Li in the chemical formula is substituted with an alkaline earth metal ion; disulfide compounds; and Fe₂(MoO₄)₃.

According to an embodiment of the present disclosure, the negative electrode 300 includes a negative electrode current collector and a negative electrode active material layer provided on at least one surface of the current collector. The negative electrode active material layer includes a negative electrode active material, a conductive material, and a binder resin. The negative electrode may include, as the negative electrode active material, one or a mixture of two or more selected from: lithium metal oxide or carbon such as non-graphitizable carbon or graphitic carbon; metal composite oxides such as LiₓFe₂O₃ (0≤x≤1), LiₓWO₂ (0≤x≤1), or SnₓMe₁₋ₓMe′_{y}O_{z} (where Me is Mn, Fe, Pb, or Ge; Me′ is Al, B, P, Si, Group 1, 2, or 3 elements of the periodic table, or halogen; 0<x≤1; 1≤y≤3; 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxides.

According to an embodiment of the present disclosure, the conductive material may be, for example, one or a mixture of two or more selected from: graphite, carbon black, carbon fibers or metal fibers, metal powder, conductive whiskers, conductive metal oxides, activated carbon, and polyphenylene derivatives. For example, the conductive material may be one or a mixture of two or more selected from natural graphite, artificial graphite, super-P, acetylene black, Ketjen black, channel black, furnace black, lamp black, thermal black, Denka black, aluminum powder, nickel powder, zinc oxide, potassium titanate, and titanium oxide.

According to an embodiment of the present disclosure, the current collector is not particularly limited as long as it has high conductivity without causing chemical changes in the battery, and may be, for example, stainless steel, copper, aluminum, nickel, titanium, calcined carbon, or a material in which the surface of aluminum or stainless steel is surface-treated with, for example, carbon, nickel, titanium, or silver.

According to an embodiment of the present disclosure, as the binder resin, a polymer conventionally used for electrodes in the art may be employed. Non-limiting examples of such binder resins may include, for example, polyvinylidene fluoride-co-hexafluoropropylene, polyvinylidene fluoride-co-trichloroethylene, polymethyl methacrylate, polyethylhexyl acrylate, polybutyl acrylate, polyacrylonitrile, polyvinylpyrrolidone, polyvinyl acetate, polyethylene-co-vinyl acetate, polyethylene oxide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxyl methyl cellulose, but are not limited thereto.

According to an embodiment of the present disclosure, the positive electrode slurry for preparing the positive electrode active material layer may include a dispersant, and the dispersant may be a pyrrolidone-based compound. Specifically, the dispersant may be N-methylpyrrolidone (ADC-01, LG Chem).

According to an embodiment of the present disclosure, the electrochemical device may further include an electrolyte E including an electrolyte salt, in which the electrolyte salt has a structure of A⁺B⁻, where A⁺ may include an alkali metal cation such as Li⁺, Na⁺, or K⁺, or an ion consisting of a combination thereof. In addition, B⁻ may be an anion such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, or C(CF₂SO₂)₃⁻, or an ion consisting of a combination thereof, and may be dissolved or dissociated in an organic solvent made of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), γ-butyrolactone, or a mixture thereof, but is not limited thereto.

According to an embodiment of the present disclosure, the electrochemical device may be a cylindrical electrochemical device including the separator 100, the positive electrode 200, and the negative electrode 300 as described above. In this case, the separator 100 described above may be interposed between the positive electrode 200 and the negative electrode 300 in the order of “separator-negative electrode-separator-positive electrode” to form an electrode assembly in a stacked form. The electrode assembly may then be wound into a jelly-roll shape and inserted into a battery can to manufacture the cylindrical electrochemical device.

FIG. 5 is a schematic view illustrating a winding process of a cylindrical electrochemical device, according to an embodiment of the present disclosure. Referring to FIG. 5, in the case of the separator 100 to which the coating layer 130 according to an embodiment of the present disclosure is applied, even when winding tension is applied in a winding process due to a step between the positive electrode 200 and the negative electrode 300, damage to the coating layer 130 as in the comparative example does not occur. Accordingly, deterioration of the lifetime of the battery may be suppressed. In addition, even during cell operation after injecting the electrolyte E, damage to the coating layer 130 due to the step may be suppressed. Thus, deterioration of the lifetime of the battery may be further suppressed.

Hereinafter, embodiments will be described in detail by way of example in order to describe the present disclosure. However, the embodiments according to the present disclosure may be modified into various other forms, and the scope of the present disclosure should not be construed as being limited to the embodiments to be described below. The embodiments described herein are provided to more completely explain the present disclosure to a person ordinarily skilled in the art.

### Example 1

### Manufacture of Porous Polymer Substrate

A polyethylene resin (weight average molecular weight: 1,000,000) was extruded, and a porous polymer substrate (total thickness: about 10 μm, porosity: 45%, air permeability: 80 s/100 cc, ER: 0.5 ohm) was manufactured by a wet method.

### Formation of Coating Layer

Al₂O₃ powder having a D50 particle size of 500 nm was prepared as inorganic particles. Polyacrylic acid (K-702, Lubrizol) having a D50 particle size of 200 nm was used as a binding polymer binder. PAM (MP15, Songkang Co., Tg: 160° C., Mw: 500,000, electrolyte swelling degree: 0%, electrolyte solubility: 0%) was used as an electrolyte-resistant polymer binder. Sodium carboxymethyl cellulose (CMC-Na) (SG-L02, GL Chem Co.) was used as a dispersant, and a polysiloxane-based material was prepared as a wetting agent.

The prepared inorganic particles, binding polymer binder, electrolyte-resistant polymer binder, dispersant, and wetting agent were added to water in a weight ratio of 90:4:2:3:1, and dispersed to prepare a slurry for forming the coating layer.

The slurry for forming the coating layer was applied to one surface of the porous polymer substrate by a bar coating method using a doctor blade, and dried with air at 50° C. using a heat gun to form a coating layer having a thickness of 2 μm.

### Example 2

In Example 2, except that PES (Poly(oxy-1,4-phenylenesulfonyl-1,4-phenylene), Sigma-Aldrich, electrolyte swelling degree: 5%, electrolyte solubility: 0%) was used as the electrolyte-resistant polymer binder, and the inorganic particles, binding polymer binder, electrolyte-resistant polymer binder, dispersant, and wetting agent were used in a weight ratio of 90:2:4:3:1, the separator was manufactured in the same manner as in Example 1.

### Example 3

In Example 3, except that the electrolyte-resistant polymer binder was SAN (Poly(styrene-co-acrylonitrile), Sigma-Aldrich, Mw: 185,000, electrolyte swelling degree: 5%, electrolyte solubility: 5%, Tg: 100° C.), and the inorganic particles, binding polymer binder, electrolyte-resistant polymer binder, dispersant, and wetting agent were used in a weight ratio of 90:2:4:3:1, the separator was manufactured in the same manner as in Example 1.

### Example 4

In Example 4, except that PEEK (Poly(oxy-1,4-phenyleneoxy-1,4-phenylenecarbonyl-1,4-phenylene), Sigma-Aldrich, Tg: 150° C., electrolyte swelling degree: 5%, electrolyte solubility: 5%) was used as the electrolyte-resistant polymer binder, and the inorganic particles, binding polymer binder, electrolyte-resistant polymer binder, dispersant, and wetting agent were used in a weight ratio of 90:2:4:3:1, the separator was manufactured in the same manner as in Example 1.

### Example 5

In Example 5, except that the thickness of the coating layer was 1 μm, the separator was manufactured in the same manner as in Example 1.

### Example 6

In Example 6, except that the thickness of the coating layer was 3 μm, the separator was manufactured in the same manner as in Example 1.

### Comparative Example 1

In Comparative Example 1, except that PAA (ASR-2006ES1_T1, Aekyung Co., Tg: 40° C., electrolyte swelling degree: 1,000%, electrolyte solubility: 70%) was used as the electrolyte-resistant polymer binder, and the inorganic particles, binding polymer binder, electrolyte-resistant polymer binder, dispersant, and wetting agent were used in a weight ratio of 90:2:4:3:1, the separator was manufactured in the same manner as in Example 1.

### Comparative Example 2

In Comparative Example 2, except that PAM (MP15, Songkang Co., Tg: 160° C., Mw: 500,000, electrolyte swelling degree: 0%, electrolyte solubility: 0%) was used as the electrolyte-resistant polymer binder, and the inorganic particles, binding polymer binder, electrolyte-resistant polymer binder, dispersant, and wetting agent were used in a weight ratio of 93.7:2:0.3:3:1, the separator was manufactured in the same manner as in Example 1.

### Comparative Example 3

In Comparative Example 3, except that PAM (MP15, Songkang Co., Tg: 160° C., Mw: 500,000, electrolyte swelling degree: 0%, electrolyte solubility: 0%) was used as the electrolyte-resistant polymer binder, and the inorganic particles, binding polymer binder, electrolyte-resistant polymer binder, dispersant, and wetting agent were used in a weight ratio of 90:1:6:2:1, the separator was manufactured in the same manner as in Example 1.

### Comparative Example 4

In Comparative Example 4, except that PVA (polyvinyl alcohol, Sigma-Aldrich, Tg: 50° C., Mw: 100,000, electrolyte swelling degree: 500%, electrolyte solubility: 50%) was used as the electrolyte-resistant polymer binder, and the inorganic particles, binding polymer binder, electrolyte-resistant polymer binder, dispersant, and wetting agent were used in a weight ratio of 90:2:4:3:1, the separator was manufactured in the same manner as in Example 1.

### Comparative Example 5

In Comparative Example 5, except that the thickness of the coating layer was 4 μm, the separator was manufactured in the same manner as in Example 1.

### <Manufacture of Cylindrical Electrochemical Device>

Cylindrical electrochemical devices were manufactured using the separators for cylindrical electrochemical devices of the above Examples and Comparative Examples, respectively.

### 1) Manufacture of Positive Electrode

A slurry for forming a positive electrode active material layer having a concentration of 50 wt % of components excluding water was prepared by mixing a positive electrode active material (LiNi_{0.8}Mn_{0.1}Co_{0.1}O₂), a conductive agent (carbon black), a dispersant (N-methylpyrrolidone, ADC-01, LG Chem), and a binder resin (a mixture of PVDF-HFP and PVDF) with water in a weight ratio of 97.5:0.7:0.14:1.66. Subsequently, the slurry was applied to the surface of an aluminum thin film (thickness: 10 μm) and dried to manufacture a positive electrode having a positive electrode active material layer having a thickness of 120 μm.

### 2) Manufacture of Negative Electrode

A slurry for forming a negative electrode active material layer having a concentration of 50 wt % of components excluding water was prepared by mixing graphite (a blend of natural graphite and artificial graphite), a conductive agent (carbon black), a dispersant (polyvinylpyrrolidone, Junsei Chemical, Japan), and a binder resin (a mixture of PVDF-HFP and PVDF) with water in a weight ratio of 97.5:0.7:0.14:1.66. Subsequently, the slurry was applied to a surface of a copper thin film (thickness: 10 μm) and dried to manufacture a negative electrode having a negative electrode active material layer having a thickness of 120 μm.

### 3) Manufacture of Cylindrical Electrochemical Device

The manufactured negative electrode and positive electrode were stacked with the separators of the above Examples and Comparative Examples interposed therebetween in the order of “separator-negative electrode-separator-positive electrode” to form an electrode assembly.

The stacked electrode assembly was wound into a jelly-roll shape to form an electrode assembly, which was then inserted into a battery can to manufacture a cylindrical electrochemical device.

### EXPERIMENTAL EXAMPLE

### Measurement of Electrolyte Swelling Degree

The electrolyte swelling degree (%) of the electrolyte-resistant polymer binders of the above Examples and Comparative Examples may be measured using Equation 1 below.

$$Swelling degree ( \% ) = \{ ( {W}_{1} - {W}_{0} ) / {W}_{0} \} \times 100 \qquad [ Equation 1 ]$$

Here, Wₒ represents the weight of the polymer material before immersion in the electrolyte, and W₁ represents the weight of the swollen polymer material after 24 hours of immersion in the electrolyte. The electrolyte was prepared by mixing ethylene carbonate (EC) and ethyl methyl carbonate (EMC) in a mass ratio of 3:7, with LiPF₆ included in an amount of 1 mol/L.

### Measurement of Electrolyte Solubility

The electrolyte solubility (%) of the electrolyte-resistant polymer binders of the above Examples and Comparative Examples may be measured using Equation 2 below.

$$Solubility ( \% ) = \{ ( {W}_{0} - {W}_{r} ) / {W}_{0} \} \times 100 \qquad [ Equation 2 ]$$

Here, Wₒ represents the weight of the polymer material before dissolution in the electrolyte, and Wᵣ represents the weight of the polymer material remaining undissolved after 24 hours of dissolution in the electrolyte. The electrolyte was prepared by mixing ethylene carbonate (EC) and ethyl methyl carbonate (EMC) in a mass ratio of 3:7, with LiPF₆ included therein in an amount of 1 mol/L.

### Measurement of Peeling Strength

For the separators of the above Examples and Comparative Examples, specimens of 7 cm×2 cm were prepared to measure peeling strength. After attaching adhesive tape to the surface of the coating layer of each prepared separator, the end portion of the separator was mounted on a UTM device (LLOYD Instrument LF Plus). A force was applied at 180° and at a measurement speed of 300 mm/min using the UTM device, and the force required to peel the coating layer from the porous polymer substrate was measured.

### Measurement of Capacity Retention

For the electrochemical devices of the above Examples and Comparative Examples, charge/discharge cycles were performed by charging at 1 C until 4.2 V at 25° C., and then discharging at a constant current of 1 C until 3.0 V. Capacity retention was measured after 100 cycles and 500 cycles, respectively.

### Separator Surface Images

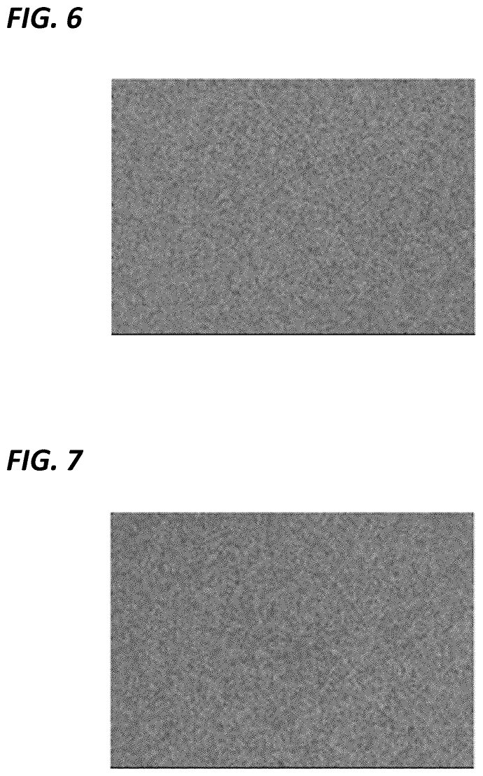

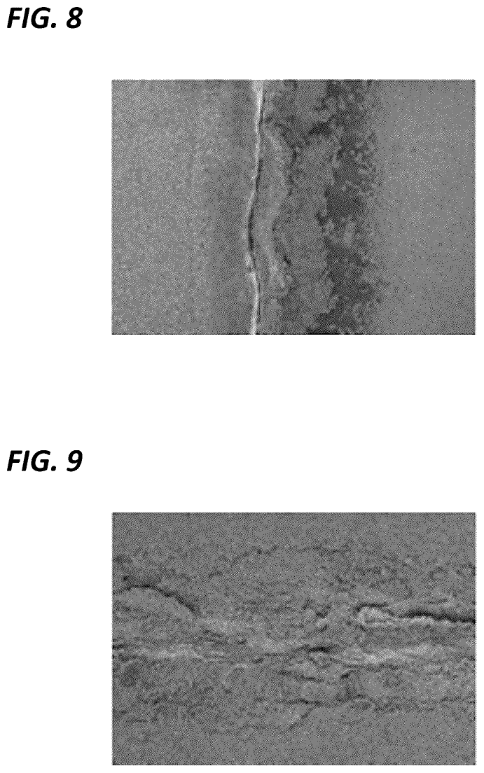

FIGS. 6 and 7 are scanning electron microscope (SEM) images, respectively, showing the surfaces of the separators of Examples 1 and 2 according to an embodiment of the present disclosure. FIGS. 8 and 9 are SEM images, respectively, showing the surfaces of the separators of Comparative Examples 1 and 2 according to an embodiment of the present disclosure.

According to the images of FIGS. 6 and 7, the separators of Examples 1 and 2 according to the present disclosure exhibited excellent electrolyte resistance, which suppressed the occurrence of damage to the coating layer and minimized the occurrence of cracks on the separator surface. Furthermore, according to FIGS. 8 and 9, in the case of Comparative Examples 1 and 2, due to inferior electrolyte resistance, damage to the coating layer occurred, and cracks were generated on the separator surface.

TABLE 1

| | | Exam. 1 | Exam. 2 | Exam. 3 | Exam. 4 | Exam. 5 | Exam. 6 |
|---|---|---|---|---|---|---|---|
| Electrolyte- | Type | PAM | PES | SAN | PEEK | PAM | PAM |
| resistant | Electrolyte | 0 | 5 | 5 | 5 | 0 | 0 |
| binder | swelling | | | | | | |
| | degree (%) | | | | | | |
| | Electrolyte | 0 | 0 | 5 | 5 | 0 | 0 |
| | solubility (%) | | | | | | |
| | Content (wt %) | 2 | 4 | 4 | 4 | 2 | 2 |
| Peeling strength (gf/cm) | | 200 | 200 | 200 | 200 | 180 | 230 |
| Separator unit resistance (ohm) | | 0.8 | 0.8 | 0.8 | 0.8 | 0.7 | 0.85 |
| Capacity | 100 cycles | 98 | 97 | 96 | 96 | 98 | 98 |
| retention | 500 cycles | 90 | 91 | 90 | 90 | 90 | 90 |
| (%) | | | | | | | |

TABLE 2

| | | Comp. | Comp. | Comp. | Comp. | Comp. |
|---|---|---|---|---|---|---|
| | | Exam. 1 | Exam. 2 | Exam. 3 | Exam. 4 | Exam. 5 |
| Electrolyte- | Type | PAA | PAM | PAM | PVA | PAM |
| resistant | Electrolyte | 1000 | 0 | 0 | 500 | 0 |
| binder | swelling | | | | | |
| | degree | | | | | |
| | (%) | | | | | |
| | Electrolyte | 70 | 0 | 0 | 50 | 0 |
| | solubility | | | | | |
| | (%) | | | | | |
| | Content | 5 | 0.3 | 6 | 4 | 2 |
| | (wt %) | | | | | |
| Peeling strength (gf/cm) | | 70 | 50 | 350 | 70 | 250 |
| Separator unit resistance | | 0.8 | 0.6 | 1.0 | 0.8 | 0.9 |
| (ohm) | | | | | | |
| Capacity | 100 cycles | 85 | 85 | 90 | 85 | 98 |
| retention | 500 cycles | 70 | 65 | 80 | 70 | 90 |
| (%) | | | | | | |

According to Table 1, in Examples 1 to 6, by including an electrolyte-resistant binder in the coating layer of the separator, the peeling strength of the separator could be increased, electrolyte resistance could be ensured to prevent damage to the coating layer during assembly, resistance could be minimized, and capacity retention could be improved. For example, the peeling strength of the separators in Examples 1 to 6 showed a relatively uniform distribution in the range of 180 gf/cm to 230 gf/cm. In addition, the capacity retention in Examples 1 to 6 was 90% or more for both 100 cycles and 500 cycles.

Furthermore, it was confirmed that in Examples 1, 5, and 6, by adjusting the thickness of the coating layer, resistance could be minimized and capacity retention could be improved.

According to Table 2, capacity retention in most of the Comparative Examples showed values of 90% or less.

For example, Comparative Example 1, which used a binder having inferior electrolyte resistance, showed lower peeling strength and lower capacity retention compared to the Examples. Comparative Example 2 had a very small content of the electrolyte-resistant binder, which resulted in a lower separator unit resistance value compared to the Examples. However, due to inferior peeling strength and electrolyte resistance, delamination of the coating layer occurred during assembly and damage to the coating layer during cycling, resulting in reduced capacity retention. Furthermore, according to FIG. 9, due to inferior electrolyte resistance, damage to the coating layer occurred and cracks were generated on the surface of the separator. In Comparative Example 3, the content of the electrolyte-resistant binder increased, which led to an increase in the separator unit resistance value and very high peeling strength. This hindered smooth pathways for lithium ions during charge/discharge, resulting in inferior capacity retention. In Comparative Example 4, the thickness of the coating layer increased, which led to an increase in peeling strength, but the resistance also increased, indicating inferior performance.

Accordingly, the separator for a cylindrical electrochemical device and the cylindrical electrochemical device including the same, according to an embodiment of the present disclosure, may increase peeling strength and minimize damage to the separator by including an electrolyte-resistant polymer binder in the coating layer, thereby maintaining high capacity retention.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below. Therefore, the technical scope of the various embodiments of the present disclosure is not limited to that in the Detailed Description section above, and may be defined by the claims.

### DESCRIPTION OF SYMBOLS

100: separator
110: porous polymer substrate
130: coating layer
200: positive electrode
300: negative electrode
E: electrolyte

What is claimed is:

1. A separator for a cylindrical electrochemical device, the separator comprising:
a porous polymer substrate; and
a coating layer provided on at least one surface of the porous polymer substrate and including a polymer binder and inorganic particles,
wherein the polymer binder included in the coating layer includes an electrolyte-resistant polymer binder and a binding polymer binder, and
the separator has a peeling strength of about 150 gf/cm or more.

2. The separator for the cylindrical electrochemical device according to claim 1, wherein
a content of the inorganic particles included in the coating layer is 90 parts by weight or more and 99 parts by weight or less, based on 100 parts by weight of the coating layer.

3. The separator for the cylindrical electrochemical device according to claim 1, wherein
a content of the polymer binder included in the coating layer is 1 part by weight or more and about 10 parts by weight or less, based on 100 parts by weight of the coating layer.

4. The separator for the cylindrical electrochemical device according to claim 1, wherein
a content of the electrolyte-resistant polymer binder included in the coating layer is 0.5 part by weight or more and about 5 parts by weight or less, based on 100 parts by weight of the coating layer.

5. The separator for the cylindrical electrochemical device according to claim 1, wherein
the electrolyte-resistant polymer binder included in the coating layer includes one or more selected from polyacrylamide (PAM), styrene-co-acrylonitrile (SAN), polyether ether ketone (PEEK), and polyether sulfone (PES).

6. The separator for the cylindrical electrochemical device according to claim 1, wherein
a content of the binding polymer binder included in the coating layer is 1 part by weight or more and about 8 parts by weight or less, based on 100 parts by weight of the coating layer.

7. The separator for the cylindrical electrochemical device according to claim 1, wherein
a content ratio of the electrolyte-resistant polymer binder to the binding polymer binder included in the coating layer is 1:2 to about 2:1.

8. The separator for the cylindrical electrochemical device according to claim 1, wherein
an electrolyte solubility of the electrolyte-resistant polymer binder included in the coating layer is 0% or more and about 10% or less.

9. The separator for the cylindrical electrochemical device according to claim 1, wherein
a swelling degree of electrolyte of the electrolyte-resistant polymer binder included in the coating layer is 0% or more and about 20% or less.

10. The separator for the cylindrical electrochemical device according to claim 1, wherein
a thickness of the coating layer is 1 μm or more and about 3 μm or less.

11. A cylindrical electrochemical device comprising:
a positive electrode; a negative electrode; and a separator interposed between the positive electrode and the negative electrode, the separator being according to claim 1.
